(19) United States
(12) Patent Application Publication
(10) Pub. No.: US 2004/0264061 A1
(43) Pub. Date: Dec. 30, 2004

(54) Stamped actuator arm

(76) Inventors: Yiren Hong, Singapore (SG); TakKoon Ooi, Singapore (SG); Yongjie Tang, Singapore (SG); ChorShan Cheng, Singapore (SG); ChoonKiat Lim, Singapore (SG)

Correspondence Address: Derek J. Berger, Seagate Technology LLC, Intellectual Property - COL2LGL, 389 Disc Drive, Longmont, CA, 80503, US

(21) Appl. No.: 10/608,285

(22) Filed: Jun. 27, 2003

(51) Int. Cl. G11B 5/55

(52) U.S. Cl. 360/265.7

(57) ABSTRACT

An actuator assembly for use in a data storage device comprises an actuator arm and a voice coil motor coil. The actuator arm has a fantail portion and an arm portion offset from the fantail portion. The voice coil motor coil is supported by the fantail portion and is lying partially beneath the arm portion.

### FIELD OF THE INVENTION

The present invention relates generally to disc drives. More particularly, the invention relates to actuator arms in disc drives.

### BACKGROUND OF THE INVENTION

Current hard disc drives having rotating discs that store information on a plurality of circular concentric data tracks on the surfaces of the discs. Data are recorded to and retrieved from the discs by a least one read/write head assembly, also known as a head or slider, which are controllably moved from track to track by an actuator assembly generating a main torque. The actuator assembly used to move the heads from track to track has historically assumed many forms, with most disc drives of the current generation incorporating an actuator of the type commonly called a rotary voice coil actuator. A typical rotary voice coil actuator consists of a pivot shaft fixed to the disc drive base adjacent the outer diameter of the disc or discs. The pivot shaft is mounted such that its central axis is normal to the plane of rotation of the discs. The actuator assembly supports a flat coil that is suspended in the magnetic field of an array of permanent magnets, which are fixed to the disc drive base.

Recent advances in storage technology have greatly increased the data storage capacity and density of magnetic storage discs. As a result, a single storage disc is now capable of storing large amounts of data that would have required a stack of several discs in the past. Some drive manufacturers have begun to produce disc drives having fewer discs, and even a single disc, as often a single disc can have storage capacity sufficient for a given application. Another industry trend is that disc drives have dropped in price causing great incentive to reduce costs, such as by reducing disc drive size or simplifying manufacturing methods. There are obvious cost advantages to having disc drives with only one disc, including having an actuator assembly with only one arm rather than multiple arms as in many prior art actuator assemblies.

Disc drives having a single disc and actuator arm also offer the opportunity to produce smaller disc drives having reduced dimensions. In the past, disc drives were often used for storage of data in personal computers and in storage arrays for storing huge amounts of data in enterprise applications. Presently, however, drives are being contemplated for use in a wide variety of consumer products, such as television set-top video recorders, video game consoles, and hand-held computers. These applications present a new set of challenges to the drive industry, requiring that drives be dimensioned smaller than ever. Presently, the drive industry measures technological advances that reduce drive and drive component dimensions by ever decreasing increments, for example, only one or two millimeters in some cases.

Another advantage to having a disc drive with a single disc and actuator arm is lower rotational inertia compared to a conventional actuator with multiple arms. Moreover, an actuator with only one arm can be produced with a single sheet of material supporting a coil at one end and a head suspension at another. This type of actuator (single-plane actuator) can be more easily manufactured than conventional actuators, such as by stamping, and its relatively low rotational inertia allows faster seek acceleration and deceleration or less seek time. On the other hand, a planar actuator arm is susceptible to vibration that can cause the arm member to bend perpendicular to the plane in which it lies, thereby increasing read-write errors while decreasing drive reliability, often culminating in drive failure.

Embodiments of the present invention provide solutions to these and other problems, and offer other advantages over the prior art.

### SUMMARY OF THE INVENTION

The present invention includes an actuator assembly for use in a data storage device that comprises an actuator arm configured to pivot about a z axis and a voice coil motor coil (VCM coil). The actuator arm includes a fantail portion and an arm portion offset from the fantail portion in a direction parallel to the z axis. The VCM coil is supported by the fantail portion and is lying partially beneath the arm portion and in a plane parallel with the arm portion. In another embodiment a disc drive includes a disc and the present actuator assembly positioned adjacent the disc. In another embodiment, a method of manufacturing an actuator assembly for use in a storage device comprises the steps of providing an actuator arm configured to pivot about a z axis, the actuator arm comprising an arm portion and a fantail portion offset from the arm portion in a direction parallel to the z axis; and providing a voice coil motor coil supported by the fantail portion and lying partially beneath the arm portion and at least partially in a plane parallel to the arm portion. In still another embodiment, a method of manufacturing a disc drive comprises the steps of providing a storage disc and providing an actuator assembly manufactured by the present methods that is positioned adjacent the disc. The inventive methods can include optimizing a position of a magnet underlying the VCM coil relative to the actuator assembly pivot.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 is an actuator arm assembly with no offset.

FIG. 3 is a section view taken along line A-A in FIG. 2 with magnet.

FIG. 4 is an actuator assembly with offset.

FIG. 5 is a section view taken along line B-B in FIG. 4 with magnet.

FIG. 6 is an embodiment of an actuator assembly of the present inventions.

FIG. 7 is a section view taken along line C-C in FIG. 6 with magnet.

FIG. 8 is a section view taken along line D-D in FIG. 6.

FIG. 9 is the section view of FIG. 7 with the position of magnet optimized for reduced pitch and roll torque.

FIG. 10 is an embodiment of an actuator arm assembly having multiple arms.

FIG. 11 is a flowchart illustrating methods of manufacturing.

### DETAILED DESCRIPTION OF ILLUSTRATIVE EMBODIMENTS

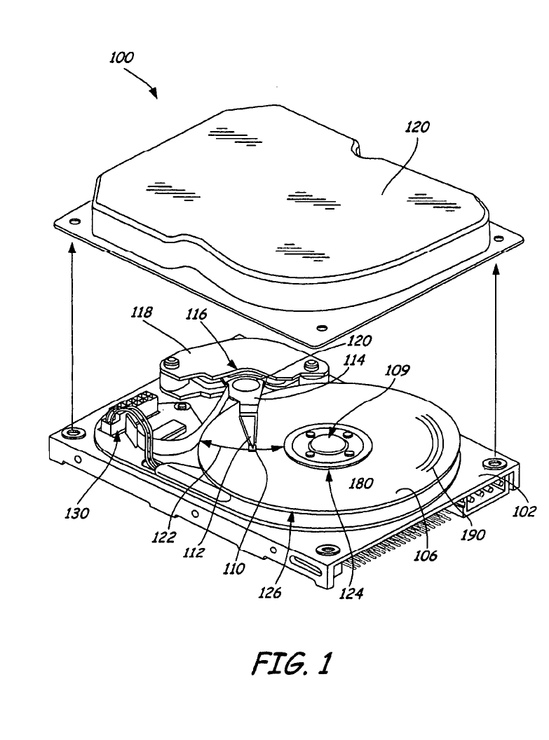

FIG. 1 is an isometric view of a disc drive 100 in which embodiments of the present invention are useful. Disc drive 100 includes a housing with a base 102 and a top cover 120. Disc drive 100 further includes one or more discs 106 or disc pack, which are rotatably mounted on a spindle motor (not shown) for co-rotation about central axis 109. Discs 106 include a surface or surfaces 180 each having a plurality of circular concentric data tracks 190 on which data are retrieved (read) and recorded (written). Each disc surface 180 has an associated disc head slider 110 which is mounted to disc drive 100 for communication with disc surface 180. In the example shown in FIG. 1, each slider 110 is supported by suspension 112 which are in turn attached to track accessing actuator arm 114 of an actuator assembly 116.

The actuator assembly 116 shown in FIG. 1 is of the type known as a rotary coil actuator and includes a voice coil motor coil (VCM coil), shown generally at 118. Varying current (and direction) is selectively applied to VCM coil 118 which moves in a constant magnetic field created by underlying magnets (not shown). The VCM coil 118 and underlying magnets interact to create force or torque, commonly called main torque, to pivot actuator arm 114 with its attached head 110 about a pivot 120. The pivoting arm 114 positions head 110 over desired data track 190 along an arcuate path 122 between a disc inner diameter 124 and a disc outer diameter 126. VCM coil 118 is driven by servo electronics 130 based on signals, generated by head 110 and a host computer (not shown). One such signal is well-known position error signal or PES signal.

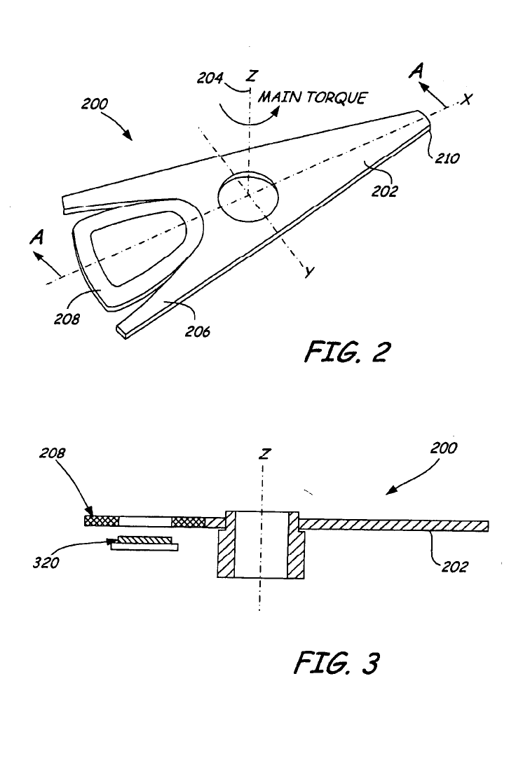

FIG. 2 is a schematic illustration of an assembly 200 pivoting from main torque about axis z illustrated as 204. Actuator assembly 200 can be stamped or molded as one piece that defines a single plane. FIG. 3 is a section view taken along line A-A in FIG. 2 and includes a cross-sectional view of magnets 320. Such planar actuators 200 are associated with simplified manufacturing and can be made of a planar sheet of material. Actuator assembly 200 can be stamped from a sheet of metallic material or molded from materials such as plastics. Actuator assembly 200 (single-plane actuator) comprises an actuator arm portion 202 which typically carries a head (shown as 110 in FIG. 1) and a fantail portion 206 supporting VCM coil 208. Also, VCM coil 208 typically lies in the same plane as arm portion 202 and fantail portion 206. The actuator arm design in FIG. 2 has been problematic due to its tendencies to bend from forces and vibrations perpendicular to its defined plane. This bending has increased read-write errors, decreased drive reliability, and has led to drive failure in some instances.

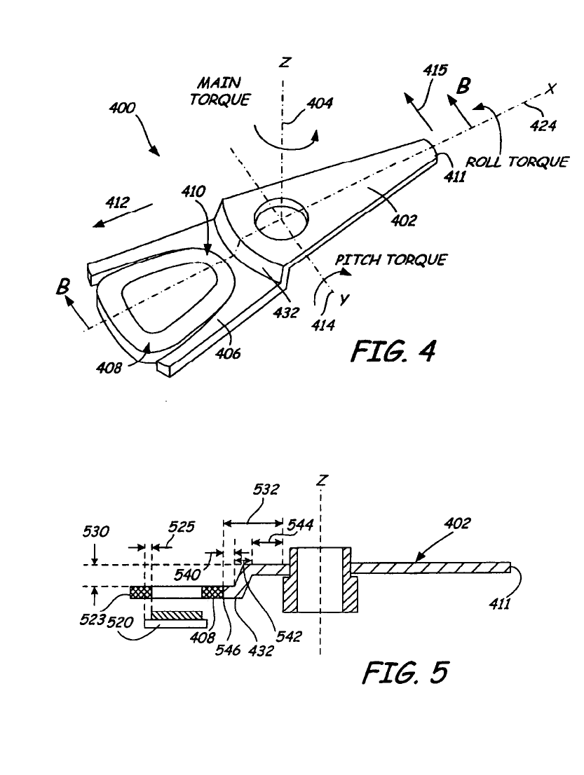

FIG. 4 illustrates another assembly 400 that generates main torque about axis z illustrated as 404. FIG. 5 is a section view taken along line B-B in FIG. 4. Actuator assembly 400 comprises arm portion 402 and fantail portion 406. Arm portion further comprises curved portion 532 (shown in FIG. 5) that connects to and supports fantail portion 406. Fantail portion 406 supports VCM coil 408 which can be positioned within the same plane. Arm portion 402 is offset from fantail portion 406 a distance or offset illustrated as 530. Arm portion 402 defines a first plane and fantail portion 406 defines a second plane. The first plane can be parallel to the second plane. Actuator assembly 400 thus defines two different planes and is called a dual-plane actuator. One problem with the arrangement illustrated in FIGS. 4 and 5 is that in some cases, VCM coil 408 has been shifted away from arm portion 402 a certain distance or inner coil shift generally indicated as 532 in FIG. 5 in the direction indicated by 412. The inner coil shift has been necessary because planar space 540, 544 on fantail portion 406 and arm portion 402, respectively, is necessary for ease of manufacturing; curved portion 532 adds additional space 542; and adhesive layer 546 is added between coil 408 and curved portion 432. In some cases, inner coil shift distance 532 has been between 3 and 4 millimeters, a huge space for a drive such as a 2.5 inch disc drive. Distance 532 can create negative clearance 525 by shifting outer coil portion 523 of coil 408 partially above magnet 520.

Magnetic leakage from magnet 520 can cause high pitch and roll torque problems. FIG. 4 illustrates the directions of pitch torque about axis y illustrated as 414 and roll torque about axis x illustrated as 424. Axis y is parallel to linear head velocity having direction indicated by arrow 415 and intersects axis z or pivot axis 404. Axis x intersects pivot axis 404 and extends distally to distal end 411 through head (not shown).

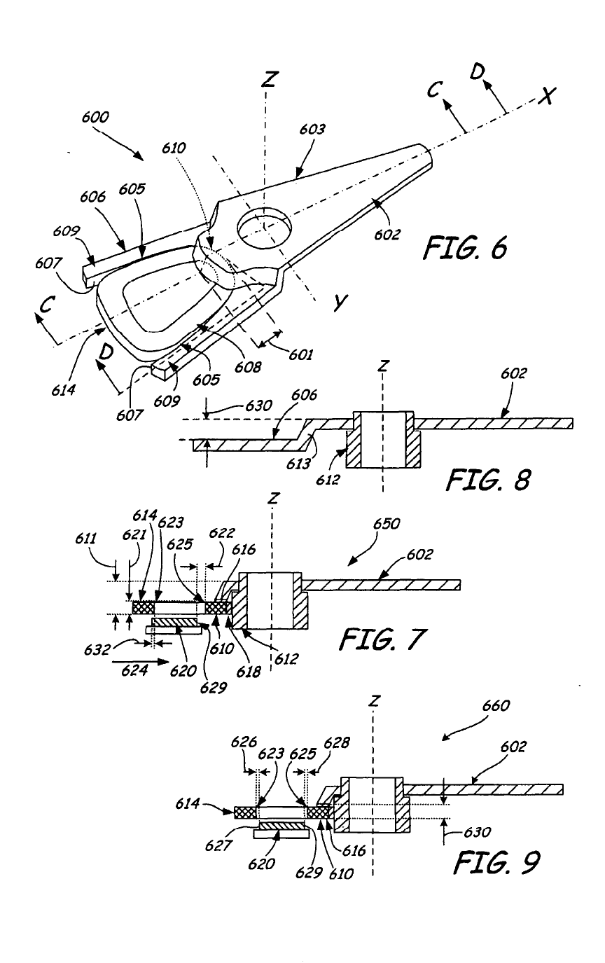

FIG. 6 illustrates an actuator assembly of the present invention and can be positioned in a disc drive 100 adjacent storage disc 106 shown in FIG. 1. FIG. 6 illustrates an actuator assembly 600 comprising actuator arm 603 and VCM coil 608. Actuator arm 603 is configured to pivot about a z axis and comprises arm portion 602 and fantail portion 606. VCM coil 608 comprises inner coil portion 610 and outer coil portion 614. FIG. 7 illustrates a section view taken along line C-C in FIG. 6. FIG. 8 is a section view taken along line D-D in FIG. 6. Arm portion 602 is offset from fantail portion 606 a distance or offset illustrated as 630 on FIG. 8 in a direction parallel to the z axis. The design of actuator assembly 600 differs from actuator assembly 400 because VCM coil 608 is lying partially beneath arm portion 602 at least partially in a plane parallel with arm portion 602.

Fantail portion 606 supports VCM coil 608 which can be further supported by pivot cartridge 612 shown in FIG. 7. In one embodiment, fantail portion 606 comprises two side portions 609 each having inner surface 607 that supports VCM coil 608 through supporting layers 605. Side portions 609 can extend distally from arm portion 602. In another embodiment, an affixing layer 616 shown in FIG. 7 affixes inner coil portion 610 to arm portion 602. In still another embodiment, vertical layer 618 supports inner coil 610 to pivot cartridge 612. Supporting layers 605, affixing layer 616, and vertical layer 618 can comprise epoxy in most embodiments.

In some embodiments of the present inventions, arm portion 602 can define a first plane and fantail portion 606 can define a second plane. The first plane can be approximately parallel to the second plane. In some cases, the plane of the VCM coil will be the same as the second plane defined by fantail portion 606. Arm portion 602 can comprise a stepped portion 613 (shown in FIG. 8) which supports and connects to fantail portion 606. Stepped portion 613 defines the offset between arm portion 602 and fantail portion 606 and can be curved.

The offset 630 between the first and second plane can be selected for optimized mechanical and magnetic performance. Offset 630 can correlate with the combined vertical thickness 621 of VCM coil 608 plus affixing layer 616 which increases the overall structural root thickness 611 (shown on FIG. 7) of arm portion 602, underlying inner coil portion 610, and affixing layer 616. It has been discovered that increased root thickness 611 is associated at least with decreased bending tendencies in arm 603 and hence better actuator and disc drive performance. Affixing inner coil portion 610 to pivot cartridge 612 further increases structural stiffness and thus further improves actuator and disc drive performance.

In actuator assembly 650 in FIG. 7, inner coil portion 610 is shown as shifted closer pivot cartridge 612 and further away from magnetic flux from magnet 620. This inner coil shift shown generally on FIG. 6 as 601 can be selected or optimized for selected or optimized magnetic and dynamic performance.

Further, outer coil portion 614 can have negative clearance (and hence negative impact from magnet 620) indicated as 632 on FIG. 7 when inner coil portion 610 in shifted so that it is lying at least partially beneath arm portion 602. In some embodiments, actuator assembly 600, 650, 660 can be further optimized by shifting or moving magnets 620 towards cartridge 612 in the direction indicated by 624 in FIG. 7. The optimized design in FIG. 9 has similar or approximately equal values for clearance 626 and clearance 628. Clearance 626 is between edge 623 of coil 608 and edge 627 of magnet 620. Clearance 628 is between edge 625 of coil 608 and edge 629 of magnet 620.

For the optimized magnetic actuator 660 in FIG. 9, the magnetic leakage has been found to be less than in other actuator assemblies such as shown in FIG. 7. Therefore, actuator assembly 660 has a decreased pitch and roll torque compared with actuator assembly 650. According to experiments, the pitch torque is reduced at least 30-35% at when head 110 is at inner diameter 124 or outer diameter 126 of disc 106 in FIG. 1. As mentioned previously, pitch and roll torque tends to reach maximum values when the head is near the inner and outer diameters of a disc.

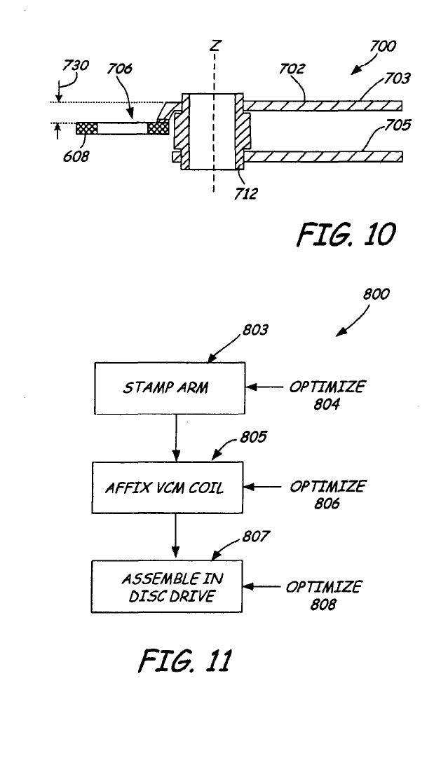

FIG. 10 is a schematic illustration of actuator assembly 700 having a plurality of arms 703, 705 for use with a stack of individual discs 106 shown generally in FIG. 1. Arm 703 is one embodiment of the present inventions similar to actuator assembly 600. Arm 703 pivots about a z axis and comprises arm portion 702 and fantail portion 706 offset from arm portion 702 a distance or offset 730 parallel to the z axis. VCM coil 608 is supported by fantail portion 706 and is lying at least partially beneath arm portion 702. Arm 705 can be planar arm portion such as shown in FIGS. 2-9 but does not require a connected fantail portion to support VCM coil as indicated. Actuator assembly 700 is also associated with increased magnetic and dynamic performance over prior art actuator assemblies and disc drives.

It should be noted that although FIG. 10 shows only two arms 703 and 705, actuator assembly 700 is contemplated to have any number of arms 703 and 705 adjacent to disc surfaces of a disc stack or stacks in storage devices such as disc drives. It is further noted that the orientation shown in FIG. 10 is illustrative only and it is contemplated that the actuator assembly 700 can be flipped over or turned on one side so as to be oriented vertically or at various angles. Finally, arms 703 and 705 as well as embodiments showing a single actuator arm are contemplated to comprise heads on one or both sides of the actuator arm.

FIG. 11 is a flowchart illustrating method of manufacture of the present inventions. Method 800 comprises a plurality of steps including manufacturing an actuator assembly and can include placing the actuator assembly into a storage device such as a disc drive. Step 803 comprises providing an actuator arm that is configured to pivot about a z axis and has an arm portion and a fantail portion offset from the arm portion in a direction parallel to the z axis. The actuator arm can be one piece that is stamped from a sheet of metallic material or molded, such as by injection molding, from materials such as plastics. Step 803 can further include step 804 of optimizing, especially by selecting an offset between two positions or planes defined by the arm portion and the fantail portion, respectively, which may or may not be parallel. Such an offset is indicated generally as 630 on FIG. 8.

Step 805 comprises providing a VCM coil supported by the fantail portion and is lying partially beneath the arm portion and partially in a plane parallel to the arm portion. Step 805 can comprise affixing VCM coil to fantail portion and arm portion using layers of affixing agents that can comprise epoxy. Step 805 can include affixing and supporting the VCM coil to the pivot cartridge, also by means of an affixing agent such as epoxy. Further, step 805 can include step 806 of optimizing the distance or shift that the VCM coil is shifted beneath the arm portion. Such an inner coil shift is indicated generally as 601 on FIG. 6.

Step 807 includes assembling the actuator assembly into a storage device such as a disc drive. The actuator assembly is positioned adjacent at least one storage disc. Step 807 can include step 808 of optimizing the position of magnets typically beneath the VCM coil. Generally, the position of these magnets can be optimized by being shifted closer to the pivot cartridge. In some embodiments, the clearances between magnet and both the inner and outer coil portions of the VCM coil are approximately equal.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the actuator assembly system while maintaining substantially the same functionality without departing from the scope and spirit of the present invention. In addition, although the preferred embodiment described herein is directed to a actuator assembly system for a data storage device, it will be appreciated by those skilled in the art that the teachings of the present invention can be applied to storage devices such as disc drives and associated manufacturing methods, without departing from the scope and spirit of the present invention.

What is claimed is:

1. An actuator assembly for use in a data storage device comprising:
an actuator arm configured to pivot about a z axis comprising:
a fantail portion;
an arm portion offset from the fantail portion in a direction parallel to the z axis; and
a voice coil motor coil supported by the fantail portion and lying partially beneath the arm portion and at least partially in a plane parallel with the arm portion.

2. The actuator assembly of claim 1 wherein arm portion defines a first plane and the fantail portion defines a second plane, wherein the second plane and the plane of the voice coil motor coil are the same.

3. The actuator assembly of claim 2 wherein the first plane is approximately parallel to the second plane.

4. The actuator assembly of claim 1 wherein the arm portion further comprises a step portion connected to the fantail portion.

5. The actuator assembly of claim 4 wherein the step portion is curved.

6. The actuator assembly of claim 1 wherein the fantail portion comprises two side portions each having an inner surface supporting the voice coil motor coil and extending distally from the arm portion.

7. The actuator assembly of claim 6 further comprising a supporting layer between each of the inner surfaces and the voice coil motor coil, an affixing layer between the voice coil motor coil and the arm portion, and a vertical layer between the voice coil motor coil and a pivot cartridge.

8. The actuator assembly of claim 7 wherein the supporting layers, the affixing layer, and the vertical layer comprise epoxy.

9. A disc drive comprising:
a storage disc; and
the actuator assembly of claim 1 positioned adjacent the storage disc.

10. An actuator assembly for use in a data storage device comprising:
an arm portion; and
means for supporting a voice coil motor coil at least partially beneath the arm portion.

11. The actuator assembly of claim 10 wherein the arm portion defines a first plane and the means for supporting the voice coil motor coil defines a second plane.

12. The actuator assembly of claim 11 wherein the first plane is approximately parallel to the second plane.

13. A method of manufacturing an actuator assembly for use in a storage device comprising the steps of:
providing an actuator arm configured to pivot about a z axis, the actuator arm
comprising an arm portion and a fantail portion offset from the arm portion in a direction parallel to the z axis; and
providing a voice coil motor coil supported by the fantail portion, the voice coil motor coil lying at least partially beneath the arm portion and at least partially in a plane parallel to the arm portion.

14. The method of claim 13 wherein the step of providing an actuator arm comprises forming the actuator arm by stamping.

15. The method of claim 13 wherein providing an actuator arm further comprises providing an arm portion defining a first plane and a fantail portion defining a second plane, wherein the second plane and the plane of the voice coil motor coil are the same.

16. The method of claim 15 wherein the first plane is approximately parallel to the second plane.

17. The method of claim 13 further comprising affixing the voice coil motor coil to the storage device.

18. The method of claim 17 wherein the affixing comprises providing an epoxy layer between the voice coil motor and each of the fantail portion, the arm portion, and a pivot cartridge.

19. A method of manufacturing a disc drive comprising the steps of:
providing a storage disc;
providing an actuator assembly manufactured by the method of claim 13 adjacent the storage disc.

20. The method of claim 19 wherein providing an actuator assembly further comprises:
providing the actuator assembly pivoting on a pivot mounted to a base; and
optimizing a position of a magnet relative to a pivot cartridge, the magnet underlying the voice coil motor coil.
